(19) United States
(12) Patent Application Publication
(10) Pub. No.: US 2015/0140374 A1
(43) Pub. Date: May 21, 2015

(54) BATTERY STATE CONTROL CIRCUIT, BATTERY STATE CONTROL APPARATUS, AND BATTERY PACK

(71) Applicants: Norifumi Yamamoto, Kanagawa (JP); Akira NAKAMURA, Chiba (JP)

(72) Inventors: Norifumi Yamamoto, Kanagawa (JP); Akira NAKAMURA, Chiba (JP)

(73) Assignee: RICOH COMPANY, LTD., Tokyo (JP)

(21) Appl. No.: 14/522,704

(22) Filed: Oct. 24, 2014

(30) Foreign Application Priority Data
Nov. 15, 2013 (JP) 2013-237294
Mar. 3, 2014 (JP) 2014-040239

(51) Int. Cl. H01M 10/48

(52) U.S. Cl. CPC H01M 10/482; H01M 2010/4271
USPC 429/61

(57) ABSTRACT

A battery state control circuit is provided for use in a battery pack including a plurality of battery units connected in series, and a plurality of coils connected in parallel with the plurality of battery units respectively. The battery state control circuit includes one or more switching elements each connected between one of the coils and a corresponding one of the battery units, wherein turning ON and OFF of the switching elements is controlled based on a difference between a voltage at a first junction point where a corresponding one of the switching elements and a corresponding one of the coils are in contact and a voltage at a second junction point where the corresponding one of the switching elements and a corresponding one of the battery units are in contact.

### BACKGROUND OF THE INVENTION

1. Field of the Invention

The present invention relates to a battery state control circuit including a plurality of rechargeable battery units, and relates to a battery state control apparatus and a battery pack each including the battery state control circuit.

2. Description of the Related Art

Conventionally, a battery pack in which a plurality of secondary batteries (cells) are connected in series is known, and the battery pack includes an electric circuit adapted to adjust voltages of the secondary batteries to ensure a uniform battery voltage for the secondary batteries.

In the battery pack according to the related art, the voltages of the secondary batteries are equalized by the electric circuit so as to ensure a uniform battery voltage, so that the manufacturing variations of the secondary batteries and the characteristic differences between the secondary batteries due to cycle degradation or secular changes are prevented.

For example, Japanese Laid-Open Patent Publication No. 2011-182484 discloses a secondary battery protection circuit including a plurality switches connected in parallel to a plurality of secondary batteries, respectively. When the secondary batteries are being charged, a switch connected to a secondary battery whose battery voltage is greater than or equal to a predetermined return voltage is turned ON, and when all the battery voltages of the secondary batteries become greater than or equal to the return voltage, the switch is turned OFF.

Japanese Laid-Open Patent Publication No. 2011-083182 discloses a battery circuit including a first battery cell with a first parameter having a first value and a second battery cell with a second parameter having a second value, the first battery cell and the second battery cell being connected in series. In this battery circuit, if the first value of the first parameter is greater than the second value of the second parameter, electrical energy transferred from the first battery cell via a first winding connected to the first battery cell is stored, and the stored energy is released to the second battery cell via a second winding connected to the second battery cell.

In the battery pack according to the related art, the switching operation of the switches is controlled based on the voltages of the secondary batteries, and the battery pack according to the related art requires a device or a circuit that monitors the voltages of the secondary batteries. Hence, in the battery pack according to the related art, the number of component parts increases in proportion to the number of secondary batteries and the monitoring circuit structure becomes increasingly complicated. Accordingly, it is difficult to meet the recent demands in the field, such as downsized battery packs.

### SUMMARY OF THE INVENTION

In one aspect, the present invention provides a battery state control circuit which ensures uniform battery voltage for the plurality of secondary batteries with a simple structure.

In an embodiment which solves or reduces one or more of the above-mentioned problems, the present invention provides a battery state control circuit for use in a battery pack including a plurality of battery units connected in series, each of the plurality of battery units being rechargeable, and a plurality of coils connected in parallel with the plurality of battery units respectively, the battery state control circuit including: one or more switching elements each connected between one of the plurality of coils and a corresponding one of the plurality of battery units, wherein turning ON and OFF of the switching elements is controlled based on a difference between a voltage at a first junction point where a corresponding one of the switching elements and a corresponding one of the plurality of coils are in contact and a voltage at a second junction point where the corresponding one of the switching elements and a corresponding one of the plurality of battery units are in contact.

Other objects, features and advantages of the present invention will become more apparent from the following detailed description when read in conjunction with the accompanying drawings.

### BRIEF DESCRIPTION OF THE DRAWINGS

FIG. 1 is a circuit diagram showing a battery pack according to a first embodiment.

FIG. 2 is a diagram showing current waveforms of respective coils of the battery pack in a current discontinuity mode.

FIG. 3 is a circuit diagram showing a battery pack according to a second embodiment.

FIG. 4 is a diagram showing current waveforms of respective coils of the battery pack in a current continuity mode.

### DETAILED DESCRIPTION OF THE PREFERRED EMBODIMENTS

A description will be given of embodiments with reference to the accompanying drawings.

### First Embodiment

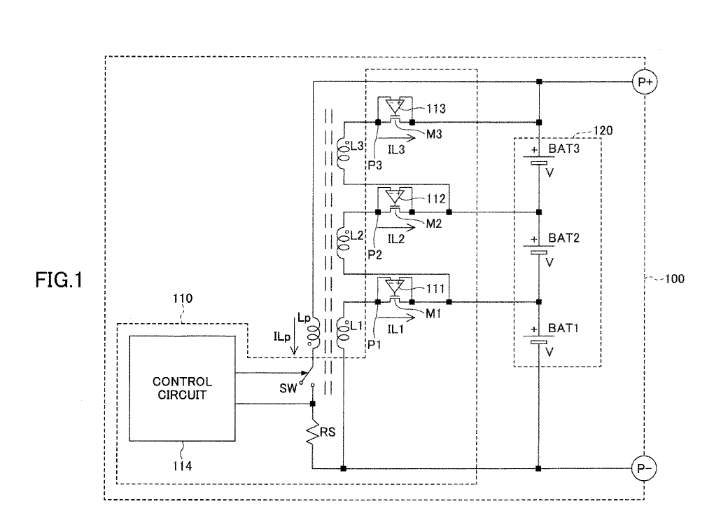

FIG. 1 shows a battery pack 100 according to a first embodiment. As shown in FIG. 1, the battery pack 100 includes a coil Lp, coils L1, L2, L3, a terminal P+, a terminal P−, a battery state control circuit 110, and a battery assembly 120.

The battery state control circuit 110 is adapted to provide uniform battery voltage for a plurality of secondary batteries included in the battery assembly 120 and adjust a battery state (electricity storage state) of each secondary battery.

The battery state control circuit 110 includes comparators 111, 112, 113, switching elements M1, M2, M3, a control circuit 114, a resistor RS, and a switching element SW. For example, the switching elements M1, M2, M3 and the switching element SW may be implemented by semiconductor switching elements, such as MOSFETs (metal oxide semiconductor field-effect transistors).

The coils Lp, L1, L2, L3 included in the battery pack 100 and the battery state control circuit 110 constitute a flyback converter circuit. The coil Lp serves as a primary-side inductor and the coils L1, L2, L3 serve as secondary-side inductors. A battery state control apparatus according to this embodiment includes the coils Lp, L1, L2, L3 and the battery state control circuit 110.

In the battery pack 100 according to this embodiment, electrical power is accumulated in the coil Lp (flyback transformer) during an ON period of the switching element SW. If the switching element SW is turned OFF, the electrical power accumulated in the coil Lp is supplied to the secondary coils L1, L2, L3 at a time due to a counter electromotive force of the coil Lp.

The battery assembly 120 includes a secondary battery BAT1, a secondary battery BAT2, and a secondary battery BAT3. The secondary batteries BAT1, BAT2, BAT3 are connected in series. A positive electrode of the secondary battery BAT3 is connected to the terminal P+, and a negative electrode of the secondary battery BAT1 is connected to the terminal P−.

The terminal P+ of the battery pack 100 is connected to a positive electrode of a charger or load (not shown), and the terminal P− of the battery pack 100 is connected to a negative electrode of the charger or load (not shown).

The positive electrode of the secondary battery BAT3 is connected to one end of the coil Lp, and the other end of the coil Lp is connected to one end of the switching element SW. The other end of the switching element SW is connected to the negative electrode of the secondary battery BAT1 via the resistor RS.

One end of the coil L1 is connected to the negative electrode of the secondary battery BAT1, and the other end of the coil L1 is connected to the positive electrode of the secondary battery BAT1 via the comparator 111 and the switching element M1.

One end of the switching element M1 is connected to the other end of the coil L1, and the other end of the switching element M1 is connected to the positive electrode of the secondary battery BAT1. An inverting input terminal of the comparator 111 is connected to the other end of the coil L1 and one end of the switching element M1, and a non-inverting input terminal of the comparator 111 is connected to the other end of the switching element M1 and the positive electrode of the secondary battery BAT1. An output signal of the comparator 111 is supplied to a gate of the switching element M1, which controls turning ON and OFF of the switching element M1.

Thus, the comparator 111 is adapted to compare a voltage (a counter electromotive voltage E of the secondary side (at a junction point P1 between the other end of the coil L1 and one end of the switching element M1 with a battery voltage of the secondary battery BAT1. When the voltage at the junction point P1 is higher than the battery voltage of the secondary battery BAT1, the comparator 111 outputs a low-level (L level) signal, which turns ON the switching element M1. The switching element M1 may be implemented by a synchronous rectification switch which operates at phase opposite to that of the switching element SW (which will be described later) and prevents the backward flow of current.

One end of the coil L2 is connected to the positive electrode of the secondary battery BAT1 (or the negative electrode of the secondary battery BAT2), and the other end of the coil L2 is connected to the positive electrode of the secondary battery BAT2 via the comparator 112 and the switching device M2.

One end of the switching element M2 is connected to the other end of the coil L2, and the other end of the switching element M2 is connected to the positive electrode of the secondary battery BAT2. An inverting input terminal of the comparator 112 is connected to the other end of the coil L2 and one end of the switching element M2, and a non-inverting input terminal of the comparator 112 is connected to the other end of the switching element M2 and the positive electrode of the secondary battery BAT2. The output of the comparator 112 is supplied to a gate of the switching element M2 to control turning ON and OFF of the switching element M2.

Similar to the comparator 111, the comparator 112 is arranged to turn ON the switching element M2 when a voltage at a junction point P2 between the other end of the coil L2 and one end of the switching element M2 is higher than a battery voltage of the secondary battery BAT2.

One end of the coil L3 is connected to the positive electrode of the secondary battery BAT2 (or the negative electrode of the secondary battery BAT3), and the other end of the coil L3 is connected to the positive electrode of the secondary battery BAT3 (or the terminal P+) via the comparator 113 and the switching element M3.

One end of the switching element 513 is connected to the other end of the coil L3, and the other end of the switching element M3 is connected to the positive electrode of the secondary battery BAT3. An inverting input terminal of the comparator 113 is connected to the other end of the coil L3 and one end of the switching element M3, and a non-inverting input terminal of the comparator 113 is connected to the other end of the switching element M3 and the positive electrode of the secondary battery BAT3. The output of the comparator 113 is supplied to a gate of the switching element M2 to control turning ON and OFF of the switching element M2.

Similar to the comparator 111, the comparator 113 is arranged to turn ON the switching element M3 when a voltage at a junction point P3 between the other end of the coil L3 and one end of the switching element M3 is higher than a battery voltage of the secondary battery BAT3.

The control circuit 114 is adapted to generate and output a control signal that controls turning ON and OFF of the switching element SW. Specifically, the control signal may be implemented by a pulse signal that turns ON the switching element SW in a predetermined timing.

Next, operation of the battery state control circuit 110 according to this embodiment is explained. In the following, it is assumed that battery voltage conditions of the battery assembly 120: a battery voltage Vbat1 of the secondary battery BAT1>a battery voltage Vbat2 of the secondary battery BAT2>a battery voltage Vbat3 of the secondary battery BAT3 hold.

Moreover, it is assumed that an operation mode in which the flyback converter circuit constituted by the coils Lp, L1, L2, L3 and the battery state control circuit 110 operates at this time is a current discontinuity mode. When the flyback converter circuit operates in the current discontinuity mode, a state in which the current ILp flowing through the coil Lp is set to zero takes place during an ON period of the switching element SW.

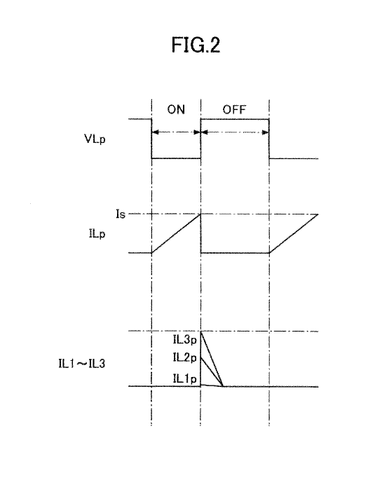

FIG. 2 shows current waveforms of the respective coils Lp, L1, L2, L3 of the battery pack 100 in the current discontinuity mode.

In the battery state control circuit 110 according to this embodiment, when the switching element SW is turned ON by a control signal output from the control circuit 114, a current ILp fl ng through the coil Lp arises. When a value of the current ILp increases and reaches a predetermined current value Is which is set by the resistor RS and the control circuit 114, the switching element SW is turned OFF. An electrical power W1 accumulated in the coil Lp at this time is represented by the following formula (1) where Lₚ denotes an inductance of the coil Lp.

$${W}_{1} = \frac{1}{2} {L}_{p} {ILp}^{2} \qquad ( 1 )$$

In the battery state control circuit 110, when the switching element SW is turned OFF, a magnetic flux φ_{B} is produced instantaneously and a counter electromotive voltage E is generated in each of the coils L1, L2, L3. Namely, at the instant, each of a voltage between the junction point P1 and the other end of the coil L1, a voltage between the junction point P2 and the other end of the coil L2, and a voltage between the junction point P3 and the other end of the coil L3 is equal to the counter electromotive voltage E. The counter electromotive voltage E is represented by the following formula (2) where N₂ denotes the number of turns of each of the secondary coils L1, L2, L3. It is assumed that the number of turns of each of the coils L1, L2, L3 in this embodiment is the same number. Hence, the counter electromotive voltage E generated in each of the coils L1, L2, L3 is equal to each other.

$$E = {N}_{2} \frac{- d {Φ}_{B}}{d t} \qquad ( 2 )$$

In the battery state control circuit 110 according to this embodiment, turning ON and OFF the switching element SW is repeated and the electrical power accumulated in the primary-side coil Lp is supplied to the secondary coils L1, L2, L3. Then, the counter electromotive voltage E is gradually increased due to the electrical power repeatedly supplied from the primary-side coil Lp. When the increased counter electromotive voltage E is higher than a battery voltage of the secondary battery connected to a corresponding one of the secondary coils, a current is supplied from the corresponding secondary coil to the secondary battery so that the secondary battery is recharged.

Here, it is assumed that a current IL1 is supplied from the secondary coil L1 to the secondary battery BAT1, a current IL2 is supplied from the secondary coil L2 to the secondary battery BAT2, and a current IL3 is supplied from the secondary coil L3 to the secondary battery BAT3, nip denotes a peak current value of the current IL1, IL2p denotes a peak current value of the current IL2, and IL3p denotes a peak current value of the current IL3. As shown in FIG. 2, these currents IL1, IL2, IL3 are supplied to the secondary batteries BAT1, BAT2, BAT3, respectively, so that the secondary batteries BAT1, BAT2, BAT3 are recharged. L₁ denotes a reactance of the coil L1, L₂ denotes a reactance of the coil L2, and L₃ denotes a reactance of the coil L3. A total electrical power W2 supplied to the secondary coils L1, L2, L3 is represented by the following formula (3).

$${W}_{2} = \frac{1}{2} {L}_{1} IL 1 {p}^{2} + \frac{1}{2} {L}_{2} IL 2 {p}^{2} + \frac{1}{2} {L}_{3} IL 3 {p}^{2} \qquad ( 3 )$$

In the following, a case where the counter electromotive voltage E generated in the secondary coil L3 is higher than a battery voltage of the secondary battery BAT3 is explained.

In the battery pack 100 according to this embodiment, the coil L3 is connected to the secondary battery BAT3 via the comparator 113 and the switching element M3. When the counter electromotive voltage E generated in the coil L3 (or the voltage at the junction point P3) is higher than the battery voltage of the secondary battery BAT3, the comparator outputs a control signal to the gate of the switching element M3, which turns ON the switching element M3. In other words, the comparator 113 turns ON the switching element M3 when the potential of the junction point P3 is higher than the potent junction point between the secondary battery BAT3 and the switching element M3. When the switching element M3 is turned ON, the current IL3 corresponding to the counter electromotive voltage E generated in the coil L3 is supplied from the coil L3 to the secondary battery BAT3 so that the secondary battery BAT3 is recharged with the supplied current IL3.

Next, operation of the battery state control circuit 110 according to this embodiment when ON resistances of the switching elements M1, M2, M3 are taken into consideration is explained.

In the battery state control circuit 110 according to this embodiment, the switching elements M1, M2, M3 may be implemented by power MOSFETs with low ON resistance, in order to reduce the loss in the internal circuits of the battery pack 100. Assuming that an ON resistance R_{sw} of each of the switching elements M1, M2, M3 is set to R_{sw}=R_{M1}=R_{M2}=R_{M3}, a current I_{sw} which flows through each of the switching elements M1, M2, M3 is represented by the following formula (4) for each of the secondary batteries.

$${I}_{SW} = \frac{E - {V}_{bat}}{{R}_{SW}} \qquad ( 4 )$$

The current I_{sw} is equivalent to each of the currents IL1, IL2, IL3 flowing through the coils L1, L2, L3, respectively. Hence, it is understood that, in the battery pack 100 according to this embodiment, a large amount of current flows through the secondary battery with a low battery voltage.

In the foregoing embodiment, the battery voltage Vbat3 of the secondary battery BAT3 is the lowest voltage among the three secondary batteries BAT1-BAT3. Hence, the counter electromotive voltage E of the coil L3 is fixed to E=Vbat3+RM3×IL3≈Vbat3, and the current IL3 from the coil L3 is supplied to the secondary battery BAT3.

Assuming that IL3p denotes a peak current value of the current IL3 flowing through the coil L3, the following formula holds.

$$\frac{1}{2} {L}_{p} {ILp}^{2} = \frac{1}{2} {L}_{3} IL 3 {p}^{2} \qquad ( 5 )$$

In the above formula (5), Lₚ denotes a reactance of the coil Lp and L₃ denotes a reactance of the coil L3.

Assuming that the turns ratio of the primary-side coil Lp and the secondary coil L3 is set to Nₚ:1, the peak current value IL3p of the current IL3 flowing through the coil L3 is represented by the following formula (6).

I3p=NₚILp <6>

As described above, in this embodiment, the electrical power W1 accumulated by the current ILp in the primary-side coil Lp is supplied to the secondary battery BAT3 via the secondary coil L3 and the switching element M3 as the current IL3 with the peak current value IL3p, the current IL3 being represented by a triangular waveform. The secondary battery BAT3 hanged by the current IL3 until the switching element SW is turned ON by the control signal output from the control circuit 114.

In the battery state control circuit 110 according to this embodiment, when the switching element SW is turned OFF, one of the switching elements M1, M2, M3 connected to the secondary battery with the lowest battery voltage among the secondary batteries BAT1, BAT2, BAT3 is turned ON first. When the switching element SW is turned ON again, the supply of electrical power to the secondary battery is stopped and the accumulation of electrical power in the primary-side coil Lp is started. When the switching element SW is next turned OFF, the supply of electrical power to the secondary battery which has the lowest battery voltage among the secondary batteries BAT1, BAT2, BAT3 is started in that timing.

In the battery state control circuit 110 according to this embodiment, the electrical power obtained from the overall battery assembly 120 is accumulated in the primary-side coil Lp, and the electrical power accumulated is supplied to the secondary battery with the lowest battery voltage via the secondary coil. In this embodiment, by repeating this process, the secondary battery with the lowest battery voltage is first recharged when the switching element SW is turned OFF, and uniform battery voltage is provided for the secondary batteries of the battery assembly 120.

In the battery state control circuit 110 according to this embodiment, the secondary battery to which the electrical power from the primary-side coil is supplied is selected based on a result of the comparison between the battery voltage of the secondary battery connected to the secondary coil and the counter electromotive voltage of the secondary coil. Therefore, in this embodiment, the circuit for monitoring a battery voltage of each of the plurality of secondary batteries included in the battery assembly is not necessary, and it is possible to ensure a uniform battery voltage for the secondary batteries with a simple structure.

In the foregoing embodiment, it is assumed that the battery voltage conditions of the battery assembly 120: the battery voltage Vbat1 of the secondary battery BAT1>the battery voltage Vbat2 of the secondary battery BAT2>the battery voltage Vbat3 of the secondary battery BAT3 hold. Hence, the switching element M3 is turned ON first and the current is supplied only to the secondary battery BAT3. However, the present invention is not limited to this embodiment. For example, when the battery voltage conditions of the battery assembly 120: the battery voltage Vbat1>the battery voltage Vbat2=the battery voltage Vbat3 hold, the switching element M2 and the switching element M3 may be simultaneously turned ON first, and the secondary battery BAT2 and the secondary battery BAT3 may be recharged simultaneously.

In the foregoing embodiment, the battery assembly 120 including the three secondary batteries has been described. However, the present invention is not limited to this embodiment. The number of secondary batteries included in the battery assembly 120 may be arbitrary. In such an embodiment, even when the number of secondary batteries included in the battery assembly 120 increases, the circuit for monitoring a battery voltage of each of the second batteries is unnecessary.

In the foregoing embodiment, the comparator and the switching element such as a power MOSFET with low ON resistance are used for the comparison between the counter electromotive voltage of the secondary coil and the battery voltage of the secondary battery, and it is possible to reduce the loss when supplying electrical power to the secondary battery.

In the foregoing embodiment, the coils Lp, L1, L2, L3 and the battery state control circuit 110 constitute a flyback converter circuit. However, the present invention is not limited to this embodiment. For example, the direction of turns of the secondary coils may be opposite to the direction of turns of the secondary coils L1, L2, L3 in the foregoing embodiment. In this case, the coils Lp, L1, L2, L3 and the battery state control circuit 110 constitute a forward converter circuit. In a case of the forward converter circuit, when the switching element SW is turned OH, electrical power is supplied to the secondary coil connected to one of the secondary batteries with the lowest battery voltage.

As described above, the battery state control circuit 110 according to this embodiment can ensure a uniform battery voltage for the secondary batteries with a simple structure.

### Second Embodiment

Next, a battery pack 100A according to a second embodiment is explained. The battery pack 100A according to the second embodiment differs from the battery pack 100 according to the first embodiment in that the operation mode of the flyback converter circuit constituted by the coils Lp, L1, L2, L3 and the battery state control circuit 110 according to the first embodiment is switched between a current continuously mode and a current discontinuity mode. In the following, only the differences between the second embodiment and the first embodiment will be explained, the elements which are essentially the same as corresponding elements in the first embodiment are designated by the same reference numerals, and a description thereof will be omitted.

In the battery pack 100A according to this embodiment, the operation mode of the flyback converter circuit is switched between the current continuity mode and the current discontinuity mode by adjusting the current value of the current ILp which flows through the coil Lp. Specifically, for example, when it is intended to switch the operation mode to the current discontinuity mode, the electrical power W1 accumulated in the coil Lp is reduced to such a degree that the electrical power W1 is fully discharged during a period of an OFF state of the switching element SW. To perform this, the current value of the current ILp supplied to the coil Lp during a period of an ON state of the switching element SW is reduced.

Moreover, when it is intended to switch the operation mode to the current continuity mode, the electrical power W1 accumulated in the coil Lp is increased such that the electrical power W1 is not fully discharged during a period of an OFF state of the switching element SW. To perform this, the current value of the current ILp supplied to the coil Lp during a period of an ON state of the switching element SW is increased.

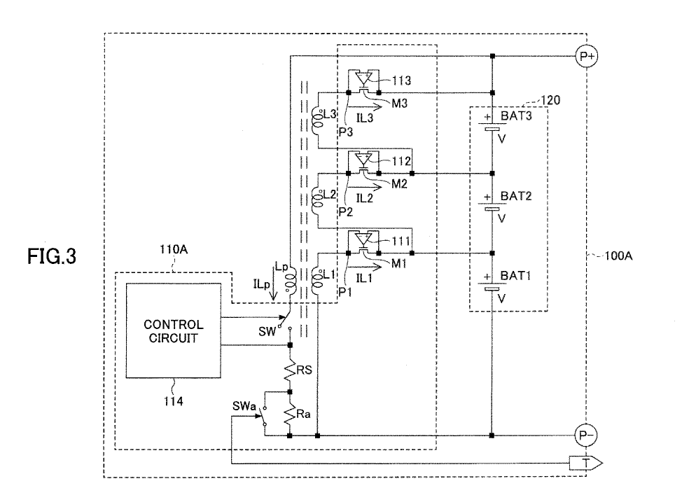

FIG. 3 shows the battery pack 100A according to the second embodiment. The battery pack 100A includes a charger connection detection terminal T and a battery state control circuit 110A. The charger connection detection terminal T is provided to detect that a charger is connected to the battery pack 100A. The battery state control circuit 110A includes a switching element SWa and a resistor Ra which are adapted to adjust a current value of the current ILp which flows through the coil Lp.

One end of the resistor Ra is connected to the resistor RS, and the other end of the resistor Ra is connected to the terminal P−. The switching element SWa is connected in parallel with the resistor Ra, and the charger connection detection terminal T is connected to a gate of the switching element SWa, the gate being provided to control turning ON and OFF of the switching element SWa.

In the battery pack 100A according to this embodiment, when it is detected that a charger (not shown) is connected to the battery pack 100A, the switching element SWa is turned ON and the resistor RS is connected to the terminal P− through the switching element SWa.

At this time, a resistance (RS+Ra) between the coil Lp and the terminal P− before the switching element SWa is turned ON is reduced to (RS), the current ILp flowing through the coil Lp is increased, and the electrical power W1 accumulated in the coil Lp is increased.

Hence, in the battery pack 100A according to this embodiment, the resistor RS, the resistor Ra, and the switching element SWa are provided to adjust the current value of the current supplied to the secondary coils L1, L2, L3 through the primary-side coil Lp.

In this case, the switching element SW is turned ON before the electrical power W1 accumulated in the coil Lp is fully discharged during a period of an OFF state of the switching element SW.

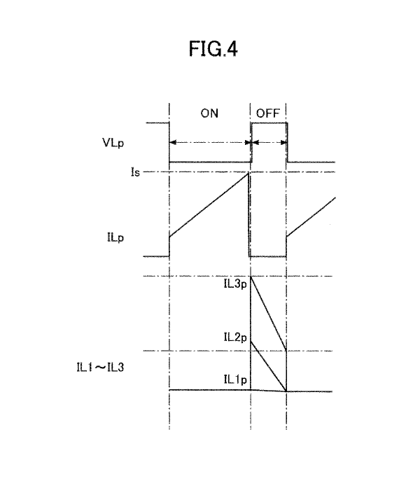

FIG. 4 shows current waveforms of the coils Lp, L1, L2, L3 of the battery pack 100A in the current continuity mode.

In the current continuity mode, the current value of the current ILp flowing through the coil Lp is large, and the current flowing through the secondary coils L1, L2, L3 is also large. Hence, recharging of the secondary battery with the lowest battery voltage is performed for a short time which is smaller than that in the current discontinuity mode, and uniform battery voltage is provided for the secondary batteries.

In the battery pack 100A according to this embodiment, the operation mode of the flyback converter circuit is switched to the current continuity mode when the charger is connected to the battery pack 100A, and uniform battery voltage for the secondary batteries may be provided in accordance with the speeds of change of the battery voltages of the second batteries due to the charging.

Furthermore, in the battery pack 100A according to this embodiment, the operation mode of the flyback converter circuit is switched to the current discontinuity mode when the charger is not connected to the battery pack 100A, and the current ILp flowing through the coil Lp may be reduced, so that the consumption of the current required for the operation of the battery state control circuit 110A may be reduced.

As described in the foregoing, it is possible for the battery pack according to the present invention to ensure a uniform battery voltage for the secondary batteries with, a simple structure.

The battery pack according to the present invention is not limited to the above-described embodiments, and variations and modifications may be made without departing from the scope of the present invention.

The present application is based upon and claims the benefit of priority of Japanese Patent Application No. 2013-237294, filed on Nov. 15, 2013, and Japanese Patent Application No. 2014-040239, filed on Mar. 3, 2014, the contents of which are incorporated herein by reference in their entirety.

What is claimed is:

1. A battery state control circuit for use in a battery pack including a plurality of battery units connected in series, each of the plurality of battery units being rechargeable, and a plurality of coils connected in parallel with the plurality of battery units respectively, the battery state control circuit comprising:
one or more switching elements each connected between one of the plurality of coils and a corresponding one of the plurality of battery units,
wherein turning ON and OFF of the switching elements is controlled based on a difference between a voltage at a first junction point where a corresponding one of the switching elements and a corresponding one of the plurality of coils are in contact and a voltage at a second junction point where the corresponding one of the switching elements and a corresponding one of the plurality of battery units are in contact.

2. The battery state control circuit according to claim 1, further comprising a comparator circuit adapted to compare the voltage at the junction point where the corresponding one of the switching elements and the one of the plurality of coils are in contact and the voltage at the junction point where the corresponding one of the switching elements and the corresponding one of the plurality of battery units are in contact,
wherein the comparator circuit turns ON the corresponding one of the switching elements when the voltage at the first junction point where the corresponding one of the switching elements and the corresponding one of the plurality of coils are in contact is higher than the voltage at the second junction point where the corresponding one of the switching elements and the corresponding one of the plurality of battery units are in contact.

3. The battery state control circuit according to claim 2, further comprising a control unit adapted to control timing of supply of electric current to the plurality of coils,
wherein, when the supply of electric current to the plurality of coils is started, one of the switching elements connected to one of the battery units with a lowest voltage is first turned ON, and electric current from a corresponding one of the plurality of coils connected to said one of the switching elements thus turned ON is supplied to said one of the battery units with the lowest voltage.

4. The battery state control circuit according to claim 3, further comprising an adjustment unit adapted to adjust a current value of the current supplied to the plurality of coils,
wherein the adjustment unit increases the current value of the supplied current in response to a predetermined detection signal.

5. A battery state control apparatus, comprising:
a primary-side coil connected in series to a plurality of battery units which are connected in series, each of the plurality of battery units being rechargeable;
a plurality of secondary coils connected in parallel with the plurality of battery units, respectively; and
one or more switching elements each connected between one of the plurality of battery units and a corresponding one of the plurality of secondary coils,
wherein turning ON and OFF of the switching elements is controlled based on a difference between a voltage at a first junction point where a corresponding one of the switching elements and a corresponding one of the plurality of secondary coils are in contact and a voltage at a second junction point where the corresponding one of the switching elements and a corresponding one of the plurality of battery units are in contact.

6. A battery pack, comprising:
a plurality of battery units which are connected in series, each of the plurality of battery units being rechargeable;
a primary-side coil connected in series to the plurality of battery units;
a plurality of secondary coils connected in parallel with the plurality of battery units, respectively; and
one or more switching elements each connected between one of the plurality of battery units and a corresponding one of the plurality of secondary coils,
wherein turning ON and OFF of the switching elements is controlled based on a difference between a voltage at a first junction point where a corresponding one of the switching elements and a corresponding one of the plurality of secondary coils are in contact and a voltage at a second junction point where the corresponding one of the switching elements and a corresponding one of the plurality of battery units are in contact.
